(19) United States
(12) Patent Application Publication
(10) Pub. No.: US 2012/0020508 A1
(43) Pub. Date: Jan. 26, 2012

(54) ELECTRONIC DEVICE WITH SPEAKER

(75) Inventors: YAO WANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/949,959

(22) Filed: Nov. 19, 2010

(30) Foreign Application Priority Data
Jul. 21, 2010 (CN) 201010232895.3

(51) Int. Cl. H04R 1/02

(52) U.S. Cl. 381/332

(57) ABSTRACT

An electronic device includes an upper housing, a lower housing, a speaker, and a cover assembly. The lower housing includes an interior surface and a supporting portion on the interior surface. The supporting portion, the speaker and the interior surface cooperatively enclose a first sound cavity. The cover assembly, the supporting portion, the speaker, and the interior surface cooperatively enclose a second sound cavity communicating with the first sound cavity. The first sound cavity and the second sound cavity communicate to the outside of the electronic device.

### BACKGROUND

1. Technical Field

The present disclosure relates to an electronic device equipped with a speaker.

2. Description of the Related Art

Electronic devices often have two or more built-in speakers. The configuration of two or more speakers can be costly and use up a lot of space in the electronic device. It is needed to decrease the number of the speakers for saving space while maintaining similar sound effects as with multiple speakers.

Therefore, there is room for improvement within the art.

### BRIEF DESCRIPTION OF THE DRAWINGS

Many aspects of the present electronic device with a speaker can be better understood with reference to the following drawings. The components in the drawings are not necessarily drawn to scale, the emphasis instead being placed upon clearly illustrating the principles of the present electronic device using the same. Moreover, in the drawings, like reference numerals designate corresponding parts throughout the several views.

FIG. 1 is an isometric assembled view of a electronic device with a speaker according to an exemplary embodiment.

FIG. 2 is another isometric view of the electronic device shown in FIG. 1 from another angle.

FIG. 3 is an isometric exploded view of the electronic device shown in FIG. 2.

FIG. 4 is another isometric view of the electronic device shown in FIG. 3 from another angle.

FIG. 5 is a cross sectional view of the electronic device shown in FIG. 1.

### DETAILED DESCRIPTION

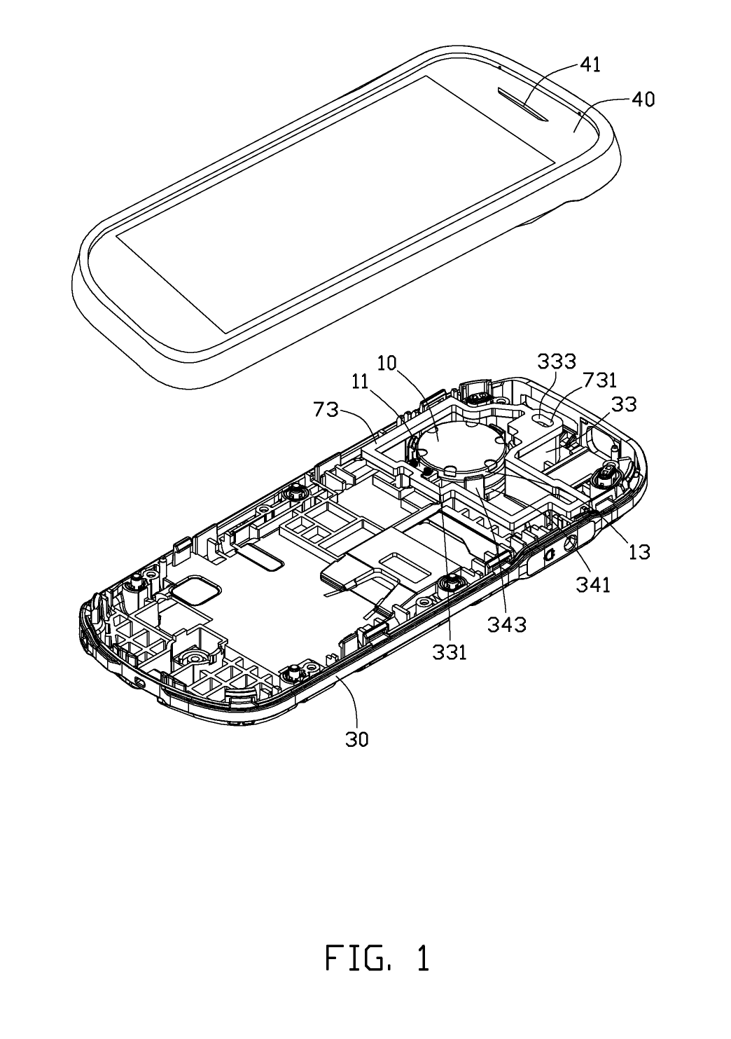

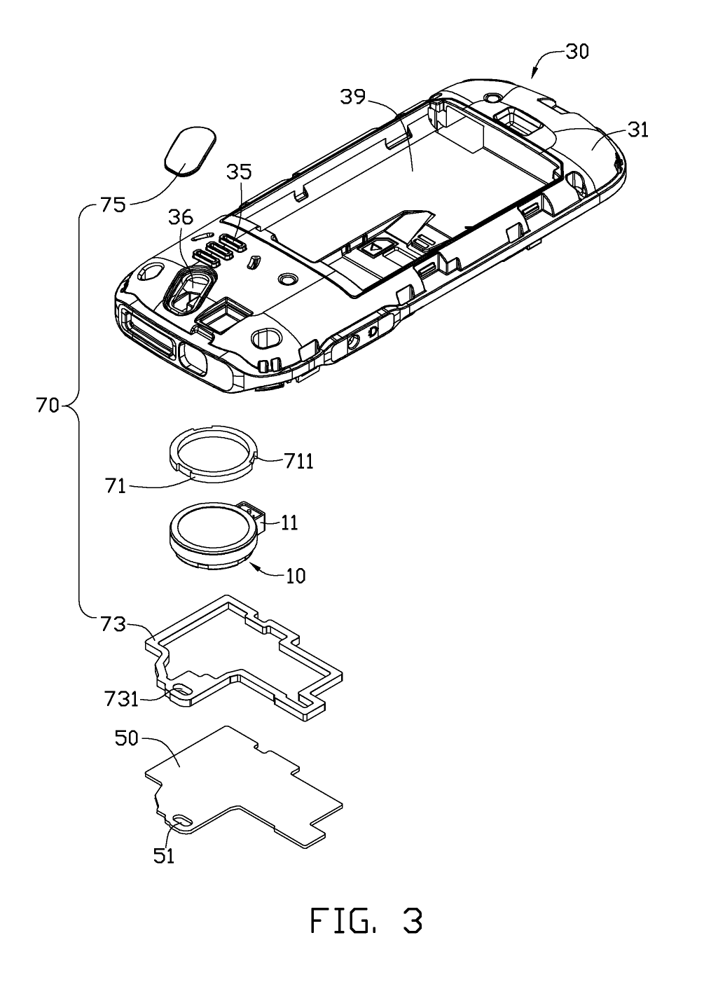

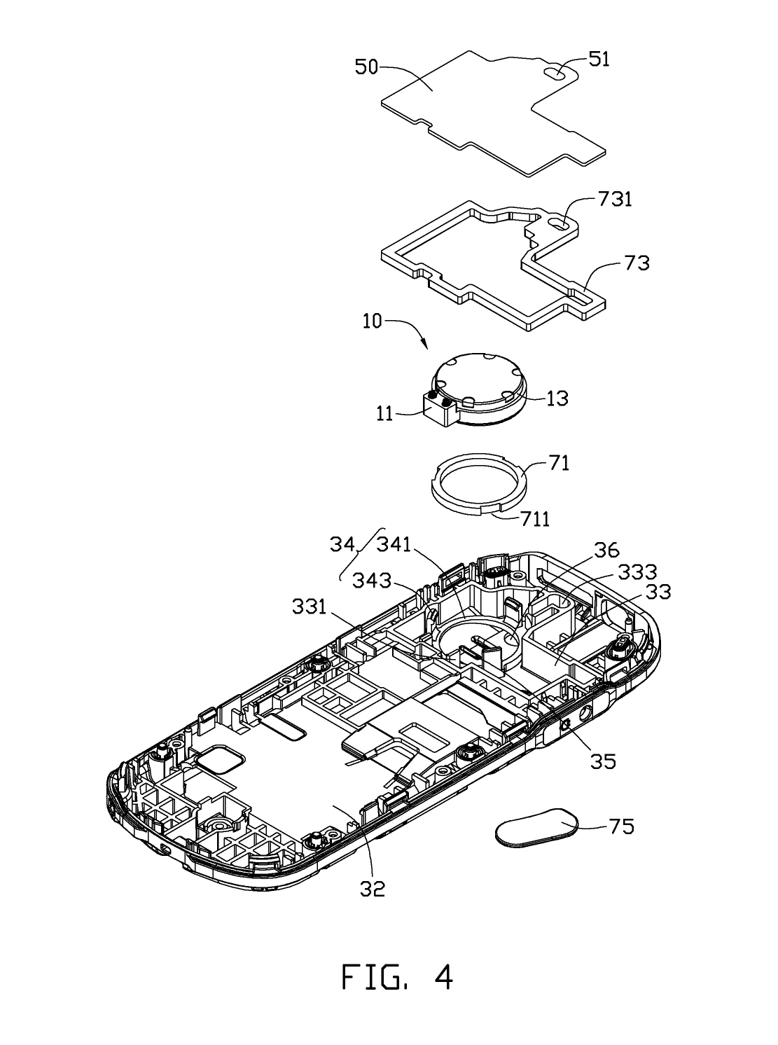

FIG. 1, FIG. 3 and FIG. 4 show an electronic device 100 according to an exemplary embodiment including a speaker 10, a lower housing 30, an upper housing 40, a printed circuit board (PCB) 50, and a cover assembly 70. The speaker 10, the PCB 50, and the cover assembly 70 are assembled in the lower housing 30.

The speaker 10 is typically circular and has a securing portion 11 extending from the circumferential side surface. The speaker 10 defines a resisting groove 13 in the circumferential side surface. The securing portion 11 abuts the resisting groove 13. The resisting groove 13 and the securing portion 11 secure the speaker 10 to the lower housing 30.

The lower housing 30 includes an exterior surface 31 and an interior surface 32. The lower housing 30 further includes a supporting portion 33, a fixing portion 34, through slots 35, and a communicating hole 36. The exterior surface 31 defines a battery receiving cavity 39. Securing arms 331 protrude from the interior surface 32 for securing to the securing portion 11. The supporting portion 33 protrudes from the interior surface 32 and forms a closed loop to surround the fixing portion 34 and the securing arms 331. The supporting portion 33 encloses a through slit 333 opposite to the securing arms 331. The through slit 333 extends perpendicular to the interior surface 32.

The fixing portion 34 includes a base portion 341 and latching arms 343. The base portion 341 protrudes from the interior surface 32, and has substantially the same shape and size as the speaker 10. The base portion 341 supports the speaker 10. The latching arms 343 are spaced from each other, and protrude from the interior surface 32 around the base portion 341. The latching arms 343 have distal ends bent towards the center of the base portion 341. The latching arms 343 engage the resisting groove 13 to latch the speaker 10 on the base portion 341.

The through slots 35 are generally parallel with each other and defined through the interior surface 32. The communicating hole 36 is defined through the lower housing 30, with an end communicating with the through slit 333 and the other opposite end extending through the bottom surface of the base portion 341.

The upper housing 40 secures to the lower housing 30. The upper housing 40 defines a sound hole 41 for aligning with the through slit 333. Accordingly, sound from the speaker 10 can transmit through the through slit 333 and the sound hole 41 to the outside. The PCB 50 may be flexible and defines a first through aperture 51 corresponding to the through slit 333.

The cover assembly 70 includes a first sealing member 71, a second sealing member 73, and a sealing cover 75. The first sealing member 71 has the same shape and size as the base portion 341 and may be made of resilient materials such as sealing cotton. The first sealing member 71 is for sealing gaps between the speaker 10 and the base portion 341. The first sealing member 71 defines a number of notches 711 corresponding to the number of latching arms 343. The latching arms 343 latch in the notches 711. The second sealing member 73 has substantially the same shape and size as the top surface of the supporting portion 33. The second sealing member 73 can be made of resilient sealing materials such as sealing cotton for sealing gaps between the PCB 50 and the supporting portion 33. The second sealing member 73 defines a second through aperture 731 corresponding to the through slit 333 and the first through aperture 51. The sealing cover 75 can be assembled to and seal the communicating hole 36.

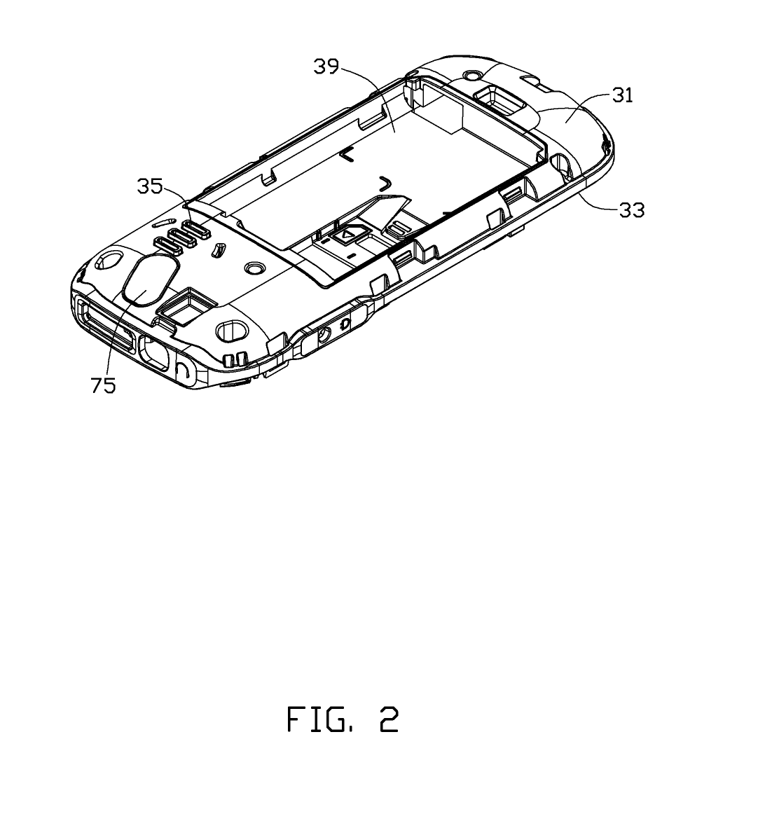

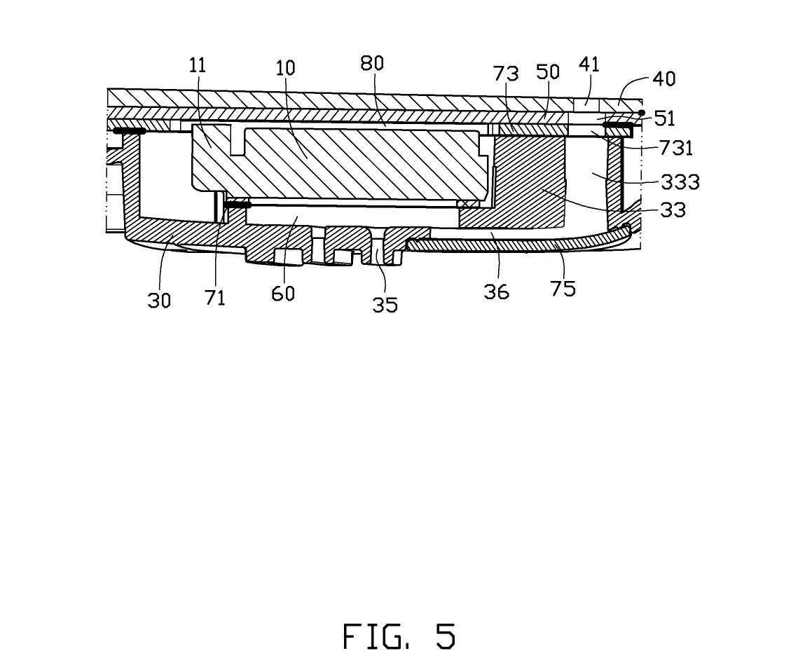

Referring further to FIG. 1, FIG. 2 and FIG. 5, during assembly, the first sealing member 71 and the speaker 10 are latched to the fixing portion 34, and the first sealing member 71 is positioned between the base portion 341 and the speaker 10. The latching arms 343 extend through the notches 711 to latch in the resisting groove 13. The securing portion 11 is secured between the securing arms 331. The speaker 10 resists against the first sealing member 71, and the first sealing member 71 seal the gaps between the speaker 10 and the base portion 341. Accordingly, the speaker 10, the first sealing member 71, and the interior surface 32 cooperatively enclose a first sound cavity 60.

The second sealing member 73 can be adhered to the top surface of the supporting portion 33. The second through aperture 731 aligns and communicates with the through slit 333 and the communicating hole 36. The upper housing 40 secures to the lower housing 30 and the PCB 50 is secured between the upper housing 40 and the second sealing member 73. The first through aperture 51 aligns and communicates with the second through aperture 731. The sound hole 41 aligns and communicates with the first through aperture 51. The PCB 50 resists against the second sealing member 73 to seal the gaps between the PCB 50 and the supporting portion 33. Accordingly, the speaker 10, the PCB 50, the second sealing member 73, and the supporting portion 33 cooperatively enclose a second sound cavity 80. The sealing cover 75 is secured to and seals the communicating hole 36.

In use, the speaker 10 can emit sound from the first sound cavity 60 and the second sound cavity 80 to the outside. The sound from the first sound cavity 60 can pass through the through slot 35 to the outside, and also pass through the communicating hole 36, the through slit 333, the second through aperture 731, the first through aperture 51 and the sound hole 41 to the outside. The communicating hole 36 can be designed to achieve various sound effect of the sound emitted through the sound hole 41. The sound from the second sound cavity 80 can pass through the communicating hole 36, the through slit 333, the second through aperture 731, the first through aperture 51 and the sound hole 41 to the outside. The second sound cavity 80 increases bass of the sound emitted through the sound hole 41.

It is to be understood that even though numerous characteristics and advantages of the present embodiments have been set forth in the foregoing description, together with details of assemblies and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device, comprising:
an upper housing;
a lower housing mating with the upper housing, the lower housing comprising an interior surface and a supporting portion on the interior surface;
a speaker secured on the interior surface and surrounded by the supporting portion, the supporting portion, the speaker and the interior surface cooperatively enclosing a first sound cavity; and
a cover assembly covering the supporting portion, the cover assembly, the supporting portion, the speaker, and the interior surface cooperatively enclosing a second sound cavity communicating with the first sound cavity, the first sound cavity and the second sound cavity communicating to the outside of the electronic device.

2. The electronic device as claimed in claim 1, wherein the sealing assembly comprises a first sealing member, the first sealing member positioned between the speaker and the interior surface to seal the first sound cavity.

3. The electronic device as claimed in claim 2, wherein the lower housing define a fixing portion, the fixing portion secures the first sealing member and the speaker on the interior surface.

4. The electronic device as claimed in claim 3, wherein the fixing portion includes latching arms, the first sealing member defines notches, the speaker defines a resisting groove, the latching arms run through the notches to latch in the resisting groove.

5. The electronic device as claimed in claim 3, wherein the lower housing defines securing arms protruding from the interior surface, the speaker has a securing portion, the securing arms secure the securing portion.

6. The electronic device as claimed in claim 1, wherein the lower housing defines through slots through the interior surface to communicate the first sound cavity to the outside of the lower housing.

7. The electronic device as claimed in claim 1, wherein the interior surface defines a communicating hole, the communicating hole communicating the first sound cavity to the second sound cavity.

8. The electronic device as claimed in claim 7, wherein the cover assembly comprises a sealing cover to seal the communicating hole from the outside of the lower housing.

9. The electronic device as claimed in claim 1, wherein the cover assembly comprises a printed circuit board and a second sealing member, the second sealing member is positioned between the printed circuit board and the supporting portion to seal the second sound cavity.

10. The electronic device as claimed in claim 9, wherein the supporting portion defines a through slit, the printed circuit board defines a first through aperture, the second sealing member defines a second through aperture, the interior surface defines a communicating hole, the communicating hole, the through slit, the second through aperture, the first through aperture communicate with another in the order to communicate the first sound cavity and the second sound cavity.

11. The electronic device as claimed in claim 10, wherein the upper housing defines a sound hole exposed to the outside of the upper housing, the sound hole communicating with the first through aperture.

12. An electronic device, comprising:
an upper housing;
a lower housing mating with the upper housing, the lower housing comprising an interior surface and a supporting portion on the interior surface;
a speaker secured to the lower housing, the supporting portion, the speaker and the interior surface cooperatively enclosing a first sound cavity communicating to the outside of the lower housing; and
a cover assembly;
wherein the cover assembly, the supporting portion, the speaker, and the interior surface cooperatively enclosing a second sound cavity communicating with the first sound cavity, the second sound cavity communicating to the outside of the upper housing.

13. The electronic device as claimed in claim 12, wherein the sealing assembly comprises a first sealing member, the first sealing member positioned between the speaker and the interior surface to seal the first sound cavity.

14. The electronic device as claimed in claim 13, wherein the lower housing define a fixing portion, the fixing portion includes latching arms, the first sealing member defines notches, the speaker defines a resisting groove, the latching arms run through the notches to latch in the resisting groove.

15. The electronic device as claimed in claim 14, wherein the lower housing defines securing arms protruding from the interior surface, the speaker has a securing portion, the securing arms secure the securing portion.

16. The electronic device as claimed in claim 12, wherein the lower housing defines through slots through the interior surface to communicate the first sound cavity to the outside of the lower housing.

17. The electronic device as claimed in claim 12, wherein the interior surface defines a communicating hole, the communicating hole communicating the first sound cavity to the second sound cavity.

18. The electronic device as claimed in claim 16, wherein the cover assembly comprises a sealing cover to seal the communicating hole from the outside of the lower housing.

19. The electronic device as claimed in claim 12, wherein the cover assembly comprises a printed circuit board and a second sealing member, the second sealing member is positioned between the printed circuit board and the supporting portion to seal the second sound cavity.

20. The electronic device as claimed in claim 19, wherein the supporting portion defines a through slit, the printed circuit board defines a first through aperture, the second sealing member defines a second through aperture, the interior surface defines a communicating hole, the communicating hole, the through slit, the second through aperture, the first through aperture communicate with another in the order to communicate the first sound cavity and the second sound cavity.
